(19) United States
(12) Patent Application Publication
(10) Pub. No.: US 2021/0259283 A1
(43) Pub. Date: Aug. 26, 2021

(54) MODIFIED PEANUT BUTTER COMPOSITION AND METHOD OF PRODUCING SAME

(71) Applicant: Doskocil Manufacturing Company, Inc., Arlington, TX (US)

(72) Inventors: Alvin KERSHMAN, Chesterfield, MO (US); Jeff SHEAR, Arlington, TX (US)

(21) Appl. No.: 17/136,302

(22) Filed: Dec. 29, 2020

Related U.S. Application Data
(60) Provisional application No. 62/981,294, filed on Feb. 25, 2020.

(51) Int. Cl. A23K 10/30; A23K 20/28; A23K 20/158; A23K 20/163; A23K 50/45

(52) U.S. Cl. CPC A23K 10/30; A23K 20/28; A23K 50/45; A23K 20/163; A23K 20/158

(57) ABSTRACT

A modified peanut butter composition is provided that includes natural peanut butter, hard butter, and silica gel or fumed silica. The modified peanut butter can also include maltodextrin and canola oil. A method of producing a modified peanut butter composition is also provided. The method includes heating a natural peanut butter to a temperature of at least 140° F., adding a hard butter to the natural peanut butter, mixing a silica gel or a fumed silica with the hard butter and natural peanut butter until a homogeneous mixture is obtained, and mixing the homogeneous mixture until the temperature is in the range of 115° F. to 130° F.

### CROSS REFERENCE TO RELATED APPLICATIONS

This application claims priority to U.S. Provisional Patent Application No. 62/981,294 filed on Feb. 25, 2020, which is hereby incorporated herein by reference.

### BACKGROUND

### Field of the Invention

The present invention relates to a modified peanut butter composition and a method of producing such a composition. In particular, the present invention relates to a modified peanut butter that is moldable and highly flavored. The modified peanut butter includes a fumed silica or silica gel. The modified peanut butter can be used in conjunction with a pet treat or a pet toy such as a rawhide.

### Background Information

Peanut butter was first patented in 1884. However, when conventional peanut butter sits for long periods of time, the peanut butter separates into a liquid portion and a solid portion. Therefore, when peanut butter is used in products such as pet treats that may sit out for long periods of time, the peanut butter drips out of the product and is thus not suitable for use.

### SUMMARY

It has been discovered that to prevent peanut butter from dripping out of conventional peanut butter-based pet treats when the treat sits for extended periods of time, fillers must be added to the peanut butter in order to hold the peanut butter together as a layer in the pet treat. However, when conventional fillers have been added to peanut butter, the peanut butter flavor is significantly diluted or deleted. Dogs in particular like peanut butter flavor, so it is undesirable to dilute or delete the peanut butter flavor of pet treat products.

Therefore, there is a need for a peanut butter that is highly moldable and can retain its shape easily without a lot of fillers. It has been found that by adding fumed silica or silica gel and hard butter to a peanut butter, the combination of fumed silica or silica gel, hard butter and peanut oil in the peanut butter creates a modified peanut butter that is moldable and also highly flavored.

The use of hard butter to add higher melting fat crystals to the formula enables the modified peanut butter to solidify at higher temperatures. Furthermore, the inclusion of fumed silica or silica gel gels the solid and liquid lipid mixture and thereby provides the desired molding effect for the modified peanut butter. Without the fumed silica or silica gel, the composition would be a hard peanut butter that could crumble easily without other fillers.

In view of the state of the known technology, one aspect of the present disclosure is to provide a modified peanut butter composition. The modified peanut butter comprises natural peanut butter, hard butter, and fumed silica or silica gel.

Another aspect of the present disclosure is to provide a method for producing a modified peanut butter composition. The method comprises heating a natural peanut butter to a temperature of at least 140° F., mixing the peanut butter until a smooth and uniform mixture is obtained, adding a hard butter to the natural peanut butter mixture, mixing a fumed silica or silica gel with the hard butter and natural peanut butter until a homogeneous mixture is obtained, and mixing the homogeneous mixture until the temperature is in the range of 115° F. to 130° F. to obtain the modified peanut butter.

Embodiments of this invention provide a modified peanut butter that is highly moldable and has moldability a composition that can sit for long periods of time without separating, thereby improving the shelf life of the modified peanut butter. As a result, dogs can lick the modified peanut butter from a rawhide pet treat or carrier without the peanut butter dripping out. Furthermore, because the modified peanut butter is moldable without adding a significant amount of filler, the modified peanut butter can maintain the peanut butter flavor while also being able to hold itself together as a layer in a pet treat.

### BRIEF DESCRIPTION OF THE DRAWINGS

Referring now to the attached drawings which form a part of this original disclosure:

FIG. 1 illustrates a modified peanut butter composition according to an embodiment; and

FIG. 2 illustrates a process of producing a modified peanut butter according to an embodiment.

### DETAILED DESCRIPTION

Selected embodiments will now be explained with reference to the drawings. It will be apparent to those skilled in the art from this disclosure that the following descriptions of the embodiments are provided for illustration only and not for the purpose of limiting the invention as defined by the appended claims and their equivalents.

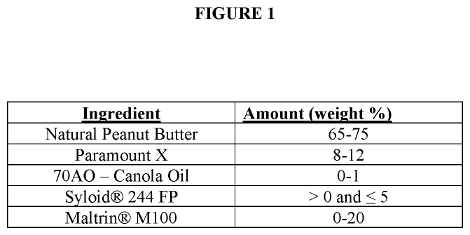

Referring initially to FIG. 1, a modified peanut butter composition is illustrated in accordance with an embodiment. The modified peanut butter composition includes approximately 65% by weight to 75% by weight of natural peanut butter, approximately 8% by weight to 12% by weight of hard butter, up to 1% by weight of canola oil, greater than 0% by weight and less than or equal to 5% by weight of fumed silica or silica gel, and up to 20% by weight of a filler. The modified peanut butter composition preferably includes 69.18% by weight of natural peanut butter, 10.20% by weight of Paramount X, 0.50% by weight of 70AO—Canola Oil, 2.00% by weight of Syloid® 244 FP, and 18.12% by weight of Maltrin® M100.

Paramount X is a trade name for hard butter, i.e., hydrogenated vegetable oil (palm oil and soybean) with soya lecithin. Although Paramount X is used in the modified peanut butter composition according to the embodiment, any suitable hard butter may be used in place of the Paramount X, such as Paramount XX, a partially hydrogenated vegetable oil. Furthermore, the hard butter may be used in melted or flake form.

70AO—Canola Oil is a trade name for canola oil. Canola oil is included in the modified peanut butter composition to improve the shelf life of the composition. Although canola oil is included in the modified peanut butter composition according to the embodiment, the modified peanut butter composition may optionally exclude canola oil. The canola oil can also be substituted with another suitable compound that improves shelf life of the product.

Syloid® 244 FP is a trade name for silica gel. It should be understood that any suitable silica gel or fumed silica can be used in place of the Syloid® 244 FP. The amount of silica ranges from greater than 0% by weight to approximately 5% by weight. However, the amount of silica gel or fumed silica that should be used in the modified peanut butter composition is preferably between 1 and 2% by weight. The use of the silica gel or fumed silica is critical to the moldability of the modified peanut butter composition.

Maltrin® M100 is a trade name for maltodextrin. Although maltodextrin is included in the modified peanut butter composition according to the embodiment, it should be understood that the modified peanut butter composition may optionally exclude maltodextrin. Furthermore, maltodextrin is used as a filler and to add a sweet flavor the composition. However, it should be understood that any suitable starch or other filler can be used in place of the Maltrin® M100.

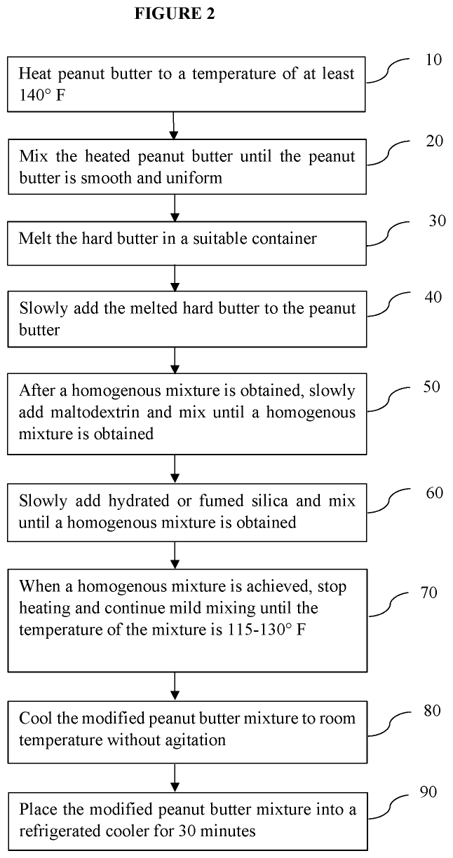

A method for producing a modified peanut butter composition in accordance with an embodiment is illustrated in FIG. 2. First, peanut butter is heated to a temperature of 140° F. in step 10. The peanut butter can be a natural peanut butter. The peanut butter can be heated in any suitable container or heater. The peanut butter can be heated to any suitable temperature of at least 140° F. to 150° F. and lower than approximately 200° F. The peanut butter is preferably heated in a planetary mixer.

In step 20, the heated peanut butter is mixed at a speed of approximately 200 rpm to 600 rpm for approximately 15-30 minutes or until the peanut butter is smooth and substantially uniform. The peanut butter can be mixed using any suitable mixer. The peanut butter is preferably mixed in a planetary mixer.

In step 30, the hard butter is melted in a suitable container. The term “hard butter” as used herein refers to edible lipids having melting characteristics or an SFI (solid fat index) curve similar to cocoa butter. The hard butter may be Paramount X, Paramount XX or any suitable hard butter as defined herein. However, it should be understood that step 30 is optional and that the hard butter need not be melted. For example, the hard butter can be added to the peanut butter in a flake form in step 40 below without being melted first.

The hard butter is then slowly added to the peanut butter as shown in step 40. In particular, the hard butter is added to the peanut butter at a mixing speed of approximately 200 rpm to 600 rpm over a period of approximately 5-10 minutes.

After a homogenous mixture is obtained, in step 50, maltodextrin is slowly added at a speed of approximately 200 rpm to 600 rpm and mixed for approximately 5-10 minutes or until a homogenous mixture is obtained. The maltodextrin can be any suitable starch or other filler. Furthermore, it should be understood that the maltodextrin may optionally be excluded from the modified peanut butter composition.

In step 60, silica gel or fumed silica is then slowly added at a speed of approximately 200 rpm to 600 rpm and mixed for approximately 5-10 minutes or until a homogenous mixture is obtained. Any suitable fumed silica or silica gel can be used in the modified peanut butter composition. Syloid® 244 FP is preferably used as the silica gel or fumed silica.

When a homogenous mixture is achieved, as shown in step 70, the heating is stopped and mild mixing at a speed of approximately 100 rpm to 200 rpm is continued for approximately 10-20 minutes or until the temperature of the mixture reaches 115° F. to 130° F. The result is a modified peanut butter mixture according to an embodiment of the invention.

The modified peanut butter mixture should be poured, placed or formed into a desired shape or mold shortly after it reaches the desired temperature of 115° F. to 130° F. In particular, if the modified peanut butter mixture is used in a pet treat or toy, the modified peanut butter mixture should be poured into the pet treat or pet toy before it is further cooled.

In step 80, the modified peanut butter mixture is cooled to room temperature without agitation. The modified peanut butter mixture can be cooled in any suitable manner. For example, the modified peanut butter mixture can be cooled after it is placed into a pet treat or pet toy.

As shown in step 90, the mixture can be further cooled by placing the modified peanut butter mixture into a refrigerated cooler for 30 minutes. The temperature of the refrigerated cooler can be any suitable temperature less than room temperature.

The modified peanut butter formed as described above result in a modified peanut butter that is highly moldable and has moldability a composition that can sit for long periods of time without separating, thereby improving the shelf life of the modified peanut butter. As a result, the modified peanut butter can be licked from a rawhide pet treat or carrier without the peanut butter dripping out. Furthermore, because the modified peanut butter is moldable without adding a significant amount of filler, the modified peanut butter can maintain the peanut butter flavor while also being able to hold itself together as a layer in a pet treat.

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “component” or “element” when used in the singular can have the dual meaning of a single part or a plurality of parts. Accordingly, these terms, as utilized to describe the present invention should be interpreted relative to a pet bowl formed of a bulk molding compound.

The term “configured” as used herein to describe a component, section or part of a device means that the component, section or part is designed to carry out the desired function.

The terms of degree, such as “substantially” as used herein mean a reasonable amount of deviation of the modified term such that the end result is not significantly changed.

While only selected embodiments have been chosen to illustrate the present invention, it will be apparent to those skilled in the art from this disclosure that various changes and modifications can be made herein without departing from the scope of the invention as defined in the appended claims. For example, the size, shape, location or orientation of the various components can be changed as needed and/or desired. Components that are shown directly connected or contacting each other can have intermediate structures disposed between them. The functions of one element can be performed by two, and vice versa. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such features. Thus, the foregoing descriptions of the embodiments according to the present invention are provided for illustration only, and not for the purpose of limiting the invention as defined by the appended claims and their equivalents.

What is claimed:

1. A modified peanut butter comprising:
natural peanut butter;
hard butter; and
silica gel or fumed silica.

2. The modified peanut butter according to claim 1,
further comprising a starch.

3. The modified peanut butter according to claim 1,
further comprising canola oil.

4. The modified peanut butter according to claim 1,
wherein the silica gel or fumed silica is Syloid® 244 FP.

5. The modified peanut butter according to claim 1,
wherein an amount of the silica gel or fumed silica ranges from greater than 0% by weight to 5% by weight.

6. The modified peanut butter according to claim 5,
wherein the amount of silica gel or fumed silica ranges from greater than 0% by weight to no more than 2.00% by weight.

7. The modified peanut butter according to claim 1,
wherein an amount of the hard butter is approximately 10% by weight.

8. A method for producing a modified peanut butter:
heating a natural peanut butter to a temperature of at least 140° F.;
mixing the natural peanut butter until a smooth and uniform mixture is obtained;
adding a hard butter to the natural peanut butter mixture;
mixing a silica gel or a fumed silica with the hard butter and natural peanut butter until a homogeneous mixture is obtained; and
mixing the homogeneous mixture until the temperature is in the range of 115° F. to 130° F. to obtain the modified peanut butter.

9. The method for producing the modified peanut butter according to claim 8,
wherein the mixing of the silica gel or the fumed silica with the hard butter and natural peanut butter is performed at a speed such that air is not added during the mixing.

10. The method for producing the modified peanut butter according to claim 8,
wherein the silica gel or the fumed silica is Syloid® 244 FP.

11. The method for producing the modified peanut butter according to claim 8,
wherein an amount of the silica gel or fumed silica mixed with the hard butter and natural peanut butter ranges from greater than 0% by weight to 5% by weight of a total weight of the silica gel or fumed silica, the hard butter and the natural peanut butter.

12. The method for producing the modified peanut butter according to claim 8,
wherein the hard butter is added to the natural peanut butter mixture in flake form.

13. The method for producing the modified peanut butter according to claim 8,
wherein the hard butter is melted prior to being added to the natural peanut butter mixture.

14. The method for producing the modified peanut butter according to claim 8,
wherein heating is continued while mixing the silica gel or the fumed silica with the hard butter and natural peanut butter, and heating is stopped when the homogeneous mixture is obtained.

15. The method for producing the modified peanut butter according to claim 8,
further comprising placing the modified peanut butter into a pet treat or pet toy while it is at the temperature of 115° F. to 130° F.

16. The method for producing the modified peanut butter according to claim 15,
further comprising cooling the modified peanut butter after it has been placed into the pet treat or pet toy.

17. The method for producing the modified peanut butter according to claim 11,
wherein the amount of silica gel or fumed silica ranges from greater than 0% by weight to no more than 2.00% by weight.

18. The method for producing the modified peanut butter according to claim 8,
wherein an amount of the hard butter is approximately 10% by weight.

19. The method for producing the modified peanut butter according to claim 8,
wherein at least one of a starch and canola oil is added to the silica gel or the fumed silica, the hard butter and the natural peanut butter before the homogeneous mixture is obtained.
